(19) United States
(12) Patent Application Publication
(10) Pub. No.: US 2023/0299435 A1
(43) Pub. Date: Sep. 21, 2023

(54) ENERGY STORAGE DEVICE AND CELL THEREOF

(71) Applicant: Guangdong Mic-Power New Energy Co., Ltd., Guangdong (CN)

(72) Inventors: Yan TONG, Guangdong (CN); Zhiyong CHEN, Guangdong (CN)

(21) Appl. No.: 18/022,188

(22) PCT Filed: Jul. 5, 2021
(86) PCT No.: PCT/CN2021/104417

§ 371 Date: Feb. 20, 2023

(30) Foreign Application Priority Data
Aug. 19, 2020 (CN) 202021743525.1

(51) Int. Cl. H01M 50/538; H01M 50/46

(52) U.S. Cl. CPC H01M 50/538; H01M 50/461

(57) ABSTRACT

Disclosed are an energy storage device and a cell thereof. The energy storage device includes: an anode sheet, a cathode sheet, and two diaphragms, one of the anode sheet and the cathode sheet being located between the two diaphragms, and the other one being located on an outer side of either of the two diaphragms, together the anode sheet, the cathode sheet, and the two diaphragms forming a spiral winding structure; at least one diaphragm has an extension exceeding beyond an end of the anode sheet and an end of the cathode sheet; the two diaphragms are of dimensions greater than that of the cathode sheet along an axial direction of the winding structure, an exceeding portion of the at least one diaphragm beyond the dimension of the cathode sheet forming a first protrusion from at least one end of the winding structure, and the first protrusion being tilted to cover the anode sheet and the cathode sheet at the end where the first protrusion is located. A technical effect of the present disclosure is that it is possible to simplify the structure of the cell and to improve the safety thereof by covering the end of the winding structure with the protrusion of the diaphragm to form the insulating layer.

### TECHNICAL FIELD

The present disclosure relates to the field of energy storage apparatus, and specifically to an energy storage device and a cell thereof.

### BACKGROUND

A cell in an energy storage device is conducted with a shell through an electrical connection part, and the remaining part of the cell is insulated from the shell. The insulation performance of the cell greatly affects the safety and reliability of the energy storage device. In the existing cell structure, there is a layer of diaphragm around the outer side of the cell. The diaphragm is used to form insulation on the outer side of the cell.

The diaphragm at the outermost layer of the prior art cell is prone to detaching which causes exposure of the cell, and the exposed cell will contact the shell and get in electrical conduction with it. In addition, the insulation at ends of the cell is insufficient, thereby degrading the safety of the cell and the energy storage device where the cell is located.

Therefore, there is a need to provide a new technical solution to solve the above technical problems.

### SUMMARY

An object of the present disclosure is to provide a new technical solution for the cell of the energy storage device.

According to an aspect of the present disclosure, a cell of an energy storage device is provided, including:

an anode sheet, a cathode sheet, and two diaphragms, one of the anode sheet and the cathode sheet being located between the two diaphragms, and the other one being located on an outer side of either of the two diaphragms, together the anode sheet, the cathode sheet, and the two diaphragms forming a spiral winding structure;

at least one diaphragm has an extension exceeding beyond an end of the anode sheet and an end of the cathode sheet;

the two diaphragms are of dimensions greater than that of the cathode sheet along an axial direction of the winding structure, an exceeding portion of the at least one diaphragm beyond the dimension of the cathode sheet forming a first protrusion from at least one end of the winding structure, and the first protrusion being tilted to cover the anode sheet and the cathode sheet at the end where the first protrusion is located.

Alternatively, the extension is provided with a second protrusion exceeding beyond two ends of the winding structure, and the second protrusion is tilted to cover the two ends.

Alternatively, the second protrusion is provided with a third protrusion which is bent toward a sidewall of the winding structure in case of the second protrusion covering the two ends.

Alternatively, dimensions of the two diaphragms are greater than that of the cathode sheet by at least 0.5 mm along the axial direction of the winding structure.

Alternatively, a dimension of the cathode sheet is greater than that of the anode sheet by at least 0.1 mm along the axial direction of the winding structure.

Alternatively, a dimension of the cathode sheet is greater than that of the anode sheet by at least 3 mm along a circumferential direction of the winding structure.

Alternatively, at least one of the two diaphragms exceeds at a starting end of the winding structure beyond the anode sheet and the cathode sheet.

Alternatively, the winding structure is formed with a through hole in the middle thereof, the through hole is provided with a cylindrical core column therein, and the cylindrical core column has an inner hole and is provided with grooves distributed along its axial direction at a sidewall of the cylindrical core column.

Alternatively, further comprising an insulation gummed paper, which fixes the extension to a sidewall of the winding structure and is provided around the sidewall.

According to another embodiment of the present disclosure, an energy storage device, comprising:

the cell of the energy storage device as described in any one of the foregoing;

a shell in which the cell is provided.

A technical effect of the present disclosure is that it is possible to simplify the structure of the cell and to improve the safety of the cell by covering the end of the winding structure with the protrusion of the diaphragm to form an insulating layer.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 is a structural schematic illustration of a winding structure according to an embodiment of the present disclosure.

FIG. 2 is a cross-sectional view at the A-A position of FIG. 1.

FIG. 3 is a partial schematic view of the cross-sectional view of the winding structure according to the embodiment of the present disclosure.

FIG. 4 is a partial schematic view of a sectional view of a winding structure according to another embodiment of the present disclosure.

FIG. 5 is a structural schematic illustration of the winding structure of one embodiment of the present disclosure provided with an insulation gummed paper.

### DESCRIPTION OF REFERENCE SIGNS

1: anode sheet, 2: cathode sheet, 3: diaphragm, 31: extension, 311: second protrusion, 312: third protrusion 32: first protrusion, 4: insulation gummed paper, 5: through hole, 6: cylindrical core column.

### DETAILED DESCRIPTION

Various exemplary embodiments of the present disclosure will now be described in detail with reference to the accompanying drawings. It should be noted that the relative arrangement, numerical expressions and numerical values of the components and steps set forth in these examples do not limit the scope of the disclosure unless otherwise specified.

The following description of at least one exemplary embodiment is in fact merely illustrative and is in no way intended as a limitation to the present disclosure and its application or use.

Techniques, methods, and apparatus known to those of ordinary skill in the relevant art may not be discussed in detail, however, the techniques, methods, and apparatus should be considered as part of the description where appropriate.

In all the examples shown and discussed herein, any specific value should be construed as merely illustrative rather than a limitation. Thus, other examples of exemplary embodiments may have different values.

It should be noted that similar reference numerals and letters denote similar items in the accompanying drawings, and therefore, once an item is defined in a drawing, there is no need for further discussion in the subsequent drawings.

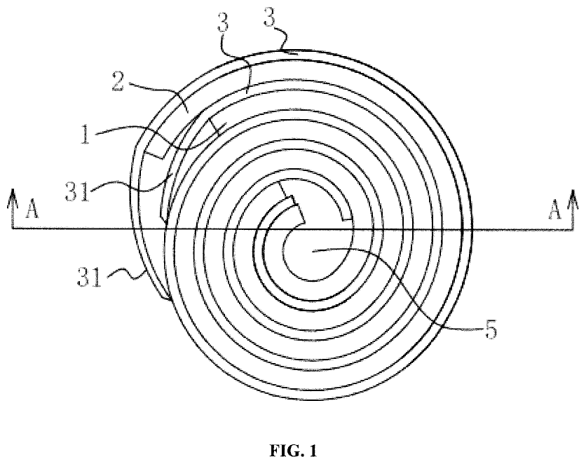

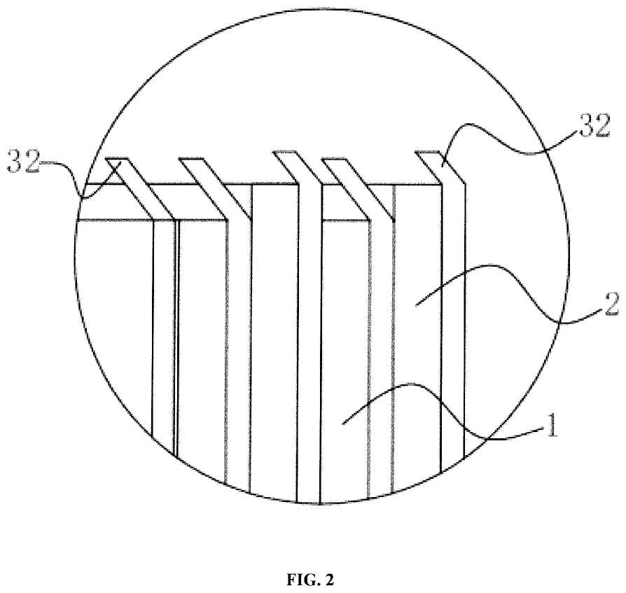

According to an embodiment of the present disclosure, a cell of an energy storage device is provided. As shown in FIGS. 1 and 2, the cell of the energy storage device includes: an anode sheet 1, a cathode sheet 2 and two diaphragms 3, one of the anode sheet 1 and the cathode sheet 2 is located between the two diaphragms 3, the other one is located on an outer side of either of the two diaphragms 3, and together the anode sheet 1, the cathode sheet 2 and the two diaphragms 3 form a spiral winding structure; at least one diaphragm 3 has an extension 31 exceeding beyond an end of the anode sheet 1 and an end of the cathode sheet 2; the two diaphragms 3 are of dimensions greater than that of the cathode sheet 2 along an axial direction of the winding structure, the portion of the at least one diaphragm 3 exceeding beyond the dimension of the cathode sheet 2 forms a first protrusion 32 from at least one end of the winding structure, and the first protrusion 32 is tilted to cover the anode sheet 1 and the cathode sheet 2 at the end thereof.

In the present embodiment, the diaphragm 3 forms an insulation between the anode sheet 1 and the cathode sheet 2, and is enveloped over the outermost layer of the winding structure. The extension 31 exceeds beyond the end of the cathode sheet 2 and covers the end to form insulation, thereby preventing the end of the cathode sheet 2 from being exposed and improving the safety of the winding structure.

At at least one end of the winding structure, the first protrusion 32 formed by at least one diaphragm 3 of the two diaphragms 3 is tilted to cover the anode sheet 1 and the cathode sheet 2 at the end thereof, thereby forming an insulating layer at the end of the winding structure.

The first protrusion 32 may also be formed at the two ends of the winding structure to form an insulating layer at the two ends.

In the structure where the first protrusion 32 is tiled at the end to form the insulating layer, the first protrusion 32 may be connected to an end of the first protrusion 32, which is wound again to the same position, in a direction from the central portion of the end to the outermost side, so as to form the insulating layer. Or, the first protrusion 32 wound again to the same position covers the inner first protrusion 32, so as to form the insulating layer.

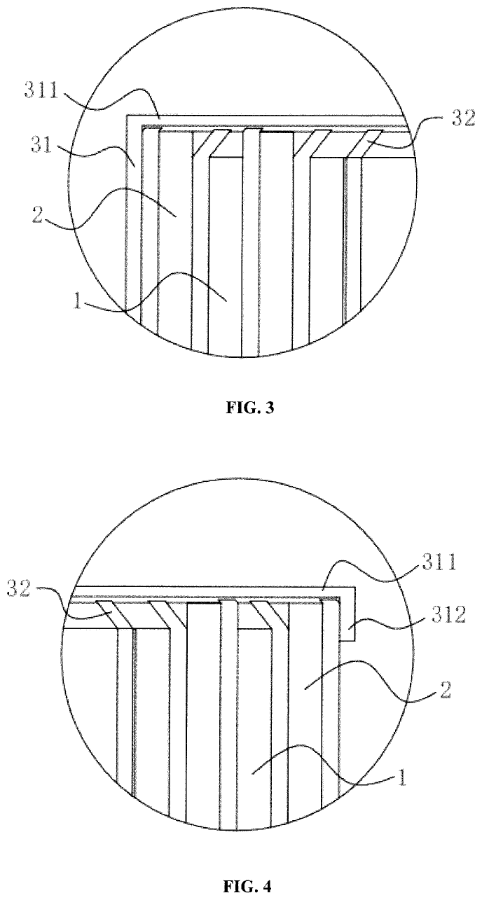

In one embodiment, as shown in FIG. 3, the extension 31 is provided with a second protrusion 311 exceeding beyond the two ends of the winding structure, and the second protrusion 311 is tiled to cover the two ends. The second protrusion 311 protrudes from the extension 31 to exceed beyond the ends, and will completely cover the ends, thus guaranteeing the reliability of the insulating layer formed at the ends.

In this embodiment, the extension 31 is provided with the second protrusion 311 exceeding beyond the two ends of the winding structure, is located on the outermost side of the winding structure, and is tiled to completely cover the ends. The insulating layer formed at ends of the winding structure by the second protrusion 311 further improves the insulating property of the ends. The second protrusion 311 may be in a shape that matches the shape of the ends of the winding structure and completely covers the ends, or in other shape that covers the end and is bent and/or wound to completely cover the end.

In an example, the extension 31 at least surrounds the circumferential direction of the sidewall of the winding structure for at least one turn.

The extension 31 surrounds the sidewall for at least one turn, can further enable fixation on the sidewall to prevent loosening of the winding structure, and can further enable insulation on the outermost side.

The second protrusion 311 may be a structure extending along the extension 31 toward the axial direction of the winding structure, and the second protrusion 311 around the circumferential direction of the sidewall of the winding structure is tiled toward the ends to form the insulating layer at the ends.

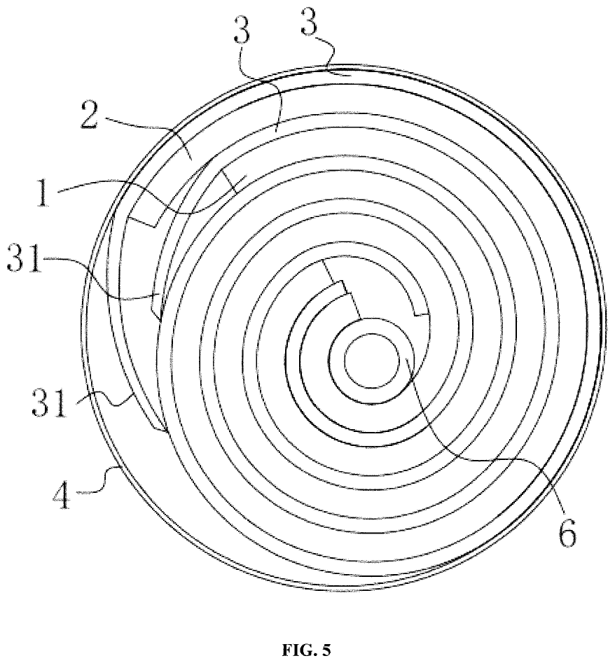

In one embodiment, as shown in FIG. 4, the second protrusion 311 is provided with a third protrusion 312, which is bent toward the sidewall of the winding structure in case of the second protrusion 311 covering the two ends.

In the present embodiment, the second protrusion 311 cover the ends, and after that, the third protrusion 312 is bent toward the sidewall along the second protrusion 311 and is fixed to the sidewall. The third protrusion 312 can enable insulation at positions where the second protrusion 311 and the end of the side wall are located, thereby enhancing the reliability of the insulating layer formed by the second protrusion 311. The third protrusion 312 covers the gap between the second protrusion 311 and the end of the sidewall, thereby further improving the insulating performance.

In one embodiment, dimensions of the two diaphragms 3 are greater than that of the cathode sheet 2 by at least 0.5 mm along the axial direction of the winding structure.

In the present embodiment, the dimension of the diaphragm 3 in the axial direction of the winding structure is larger than that of the cathode sheet 2, so that in the winding structure, there must be a diaphragm 3 sandwiched between anode sheet 1 and cathode sheet 2. With such a structure, it is possible to prevent a short-circuit between the anode sheet 1 and the cathode sheet 2, thereby improving the safety of the cell. The diaphragm 3 is greater in dimension than that of the cathode sheet 2 by at least 0.5 mm, can effectively insulate the anode sheet 1 from the cathode sheet 2, and can be tilted to cover the end after forming of the winding structure, thus achieving the purpose of covering the end to form the insulating layer.

In one embodiment, a dimension of the cathode sheet is greater than that of the anode sheet by at least 0.1 mm along the axial direction of the winding structure.

When the cell works in the energy storage device, the negative material on the cathode sheet 2 and the positive material on the anode sheet 1 act to release electric energy or store electric energy. In the case where the dimension of the cathode sheet 2 in the axial direction of the winding structure is larger than or equal to that of the anode sheet 1, it is possible to ensure that there is enough negative material to enable full charging and discharging of the positive material, thus improving the utilization of anode sheet 1. The positive material in the anode sheet 1 is generally copper while the negative material in the cathode sheet 2 is generally aluminum, and the cost of the anode sheet 1 is higher. By increasing the utilization of the anode sheet 1 in the cell so that the material with a higher cost ratio in the cell can be effectively utilized, it is possible to indirectly reduce the waste of the cost of cell. The dimension of the cathode sheet 2 being greater than that of the anode sheet 1 by at least 0.1 mm can meet the amount of the cathode sheet 2 needed to fully utilize the anode sheet 1.

For example, in the cell of the energy storage device, the positive active material provided on the anode sheet 1 is lithium. The process of charging and discharging the cell of the energy storage device includes the process in which lithium ions released from the anode sheet 1 pass through the diaphragm 3, to reach and be embedded in the cathode sheet 2. During the process, if there is not enough space on the cathode sheet 2 for receiving lithium ions, accumulation of lithium ions will occur, which will lead to potential explosion of the energy storage device, or even immediate explosion of the energy storage device in the worst case. In the present embodiment, by setting the dimension of the cathode sheet 2 to be greater than that of the anode sheet 1 along the axial direction of the winding structure, it is possible to provide enough space for receiving lithium ions, thus preventing the potential explosion risk of the energy storage device due to the accumulation of lithium ions.

In one example, the dimension of the cathode sheet 2 is greater than that of the anode sheet 1 by 0.1 mm to 0.5 mm along the axial direction of the winding structure.

Within this dimensional difference, the cathode sheet 2 meets the requirement of charging and discharging the anode sheet 1 sufficiently without rapid increasing of the volume of the cathode sheet 2 too much, and therefore, it is possible to prevent the cathode sheet 2 from making the cell too large at the same energy density.

In one embodiment, the dimension of the cathode sheet 2 is greater than that of the anode sheet 1 by at least 3 mm along the axial direction of the winding structure.

In the present embodiment, similarly, by setting the dimension of the cathode sheet 2 in the circumferential direction of the winding structure to be greater than that of the anode sheet 1 by at least 3 mm, it is possible to ensure that the anode sheet 1 sufficiently exhibits charging and discharging capability, thereby improving the utilization of the anode sheet 1 and reducing the waste of the cost of the cell.

In one embodiment, at least one of the two diaphragms 3 exceeds at a starting end of the winding structure beyond the anode sheet 1 and the cathode sheet 2.

In the present embodiment, the diaphragm 3 exceed beyond the starting end of the anode sheet 1 and the cathode sheet 2, and in the winding structure, the exceeded portion is limited in the cell, which improves the firmness of fixation of the diaphragm 3, prevents loosening of the diaphragm 3, and improves the safety of the cell.

The protrusion of the diaphragm 3 exceeds beyond the end of the winding structure, and a gummed paper 4 fixes the portion exceeding beyond the end, further improving the firmness of fixing the diaphragm 3 to the cell.

In one embodiment, the two diaphragms 3 are formed by bending one diaphragm 3.

Two diaphragms 3 formed upon bending of one diaphragm 3 makes the structure simpler, reduces the number of components, and simplifies the structure of the cell. For example, after a part of the diaphragm 3 is disposed between the anode sheet 1 and the cathode sheet 2, the other part is bent to the outer side of the anode sheet 1 or that of the cathode sheet 2, therefore forming a structure where the anode sheet 1 or the cathode sheet 2 is sandwiched in the bent diaphragm 3.

In one embodiment, as shown in FIGS. 1 and 5, the winding structure is formed with a through hole 5 in the middle thereof, the through hole 5 is provided with a cylindrical core column 6 therein, and the cylindrical core column 6 has an inner hole and is provided with grooves distributed along its axial direction at a sidewall of the cylindrical core column.

In the present embodiment, after the winding structure is formed, the winding structure is formed with the through hole 5 in the middle thereof, and by providing the cylindrical core column 6 in the through hole 5, it is possible to form supports and prevent winding structure from loosening.

The cylindrical core column 6 is provided with an inner hole, and when the cell is used in the energy storage device, it is possible to connect an electrical connection led out from the cell to the shell of the energy storage device through the inner hole, and thus there is no need to place the cell outside the shell for connection, which connection may be welding. Specifically, the cell is placed within the shell, and a welding device extends into the inner hole for welding the electrical connection and the shell, therefore preventing the problem that the electrical connection is bent too much within the shell to affect the strength since the electrical connection is too long.

The grooves provided on the sidewall of the cylindrical core column 6 are distributed along the axial direction, and can increase the friction between the cylindrical core column 6 and the anode sheet 1, the cathode sheet 2 and/or the diaphragm 3, which are located in the middle of the winding structure, thus preventing the loosening caused by sliding. A part of the winding structure which is in contact with the cylindrical core column 6, is embedded in the grooves, which can save the space, and leave more space available for the winding structure when the same space is occupied. The larger the volume of the winding structure itself, the greater the energy density of the cell.

The cylindrical core column 6 may be placed into the through hole 5 after the through hole 5 is formed. The winding structure may also be formed by coiling around the cylindrical core column 6.

In one embodiment, as shown in FIG. 5, an insulation gummed paper 4 is further included, which fixes the extension 31 to the sidewall of the winding structure, and is provided around the sidewall.

By fixing the insulation gummed paper 4 around the sidewall of the winding structure, it is possible to further fix the diaphragm 3 and the extension 31 onto the sidewall, making the diaphragm 3 and the extension 31 more firmly fixed, and securing the reliability of the insulation of the cell, therefore improving the safety of the energy storage device.

The insulation gummed paper 4 surrounds the sidewall for at least one turn and covers at least the sidewall, thereby increasing the insulation property of the sidewall.

In one example, the insulation gummed paper 4 protrudes from the end of the winding structure, and the protrusion is tiled and covers the end to form an insulating layer, thus further improving the insulation property.

In one embodiment, the anode sheet 1 and the cathode sheet 2 are each provided with an electrical connection. One of the electrical connections exceeds beyond one end of the winding structure in the axial direction, and the other exceeds beyond the other end of the winding structure. An insulating layer is arranged between the electrical connection and the corresponding end.

In the present embodiment, the insulating layer is arranged between the electrical connection on the cell and the end of the winding structure of the cell, and functions to insulate the electrical connection from partial structures of the anode sheet 1 and the cathode sheet 2 located at the end of the winding structure. The insulating layer is of a relatively small volume and has a relatively small area to be fixed between the end and the electrical connection, which is prone to causing the insulating layer to detach. The insulation gummed paper 4 may protrude from the sidewall of the winding structure, and the portion exceeding beyond the sidewall further fixes the insulating layer, which improves the firmness of the insulating layer and thus prevents the short-circuit of the cell caused by the conduction of the electrical connection with the anode sheet 1 and the cathode sheet 2 due to coming-off of the insulating layer, thereby improving security of the cell.

According to one embodiment of the present disclosure, an energy storage device is provided, including the cell of the energy storage device in any of the embodiments described above; a shell in which the cell is provided. The cell of the energy storage device is well insulated and the cell will not loosen, which prevents short-circuiting of the cell and increases the safety of the energy storage device.

The above-mentioned embodiments focus on differences between the various embodiments. Different optimization features between the various embodiments can be combined to form a better embodiment as long as they do not contradict each other, which will not be repeated herein in view of the brevity of the text.

While certain specific embodiments of the present disclosure have been illustrated by way of example, it will be understood by those skilled in the art that the foregoing examples are provided for the purpose of illustration and are not intended to limit the scope of the present disclosure. It will be understood by those skilled in the art that the foregoing embodiments may be modified without departing from the scope and spirit of the disclosure. The scope of the present disclosure is subject to the attached claims.

1. A cell of an energy storage device, comprising:
an anode sheet, a cathode sheet, and two diaphragms, one of the anode sheet and the cathode sheet being located between the two diaphragms, and the other one being located on an outer side of either of the two diaphragms, together the anode sheet, the cathode sheet, and the two diaphragms forming a spiral winding structure;
at least one diaphragm has an extension exceeding beyond an end of the anode sheet and an end of the cathode sheet; and
the two diaphragms are of dimensions greater than that of the cathode sheet along an axial direction of the winding structure, an exceeding portion of the at least one diaphragm beyond the dimension of the cathode sheet forming a first protrusion from at least one end of the winding structure, and the first protrusion being tilted to cover the anode sheet and the cathode sheet at the end where the first protrusion is located.

2. The cell of the energy storage device of claim 1, wherein the extension is provided with a second protrusion exceeding beyond two ends of the winding structure, and the second protrusion is tilted to cover the two ends.

3. The cell of the energy storage device of claim 1, wherein the second protrusion is provided with a third protrusion which is bent toward a sidewall of the winding structure in case of the second protrusion covering the two ends.

4. The cell of the energy storage device of claim 1, wherein dimensions of the two diaphragms are greater than that of the cathode sheet by at least 0.5 mm along the axial direction of the winding structure.

5. The cell of the energy storage device of claim 1, wherein a dimension of the cathode sheet is greater than that of the anode sheet by at least 0.1 mm along the axial direction of the winding structure.

6. The cell of the energy storage device of claim 1, wherein a dimension of the cathode sheet is greater than that of the anode sheet by at least 3 mm along a circumferential direction of the winding structure.

7. The cell of the energy storage device of claim 1, wherein at least one of the two diaphragms exceeds at a starting end of the winding structure beyond the anode sheet and the cathode sheet.

8. The cell of the energy storage device of claim 1, wherein the winding structure is formed with a through hole in the middle thereof, the through hole is provided with a cylindrical core column therein, and the cylindrical core column has an inner hole and is provided with grooves distributed along its axial direction at a sidewall of the cylindrical core column.

9. The cell of the energy storage device of claim 1, further comprising an insulation gummed paper, which fixes the extension to a sidewall of the winding structure and is provided around the sidewall.

10. An energy storage device, comprising:
the cell of the energy storage device of claim 1; and
a shell in which the cell is provided.
